(19) United States
(12) Patent Application Publication
(10) Pub. No.: US 2018/0033020 A1
(43) Pub. Date: Feb. 1, 2018

(54) SYSTEM AND APPARATUS FOR DETECTING FORGERY FEATURES ON IDENTIFICATION DOCUMENTS

(71) Applicant: Confirm, Inc., Boston, MA (US)

(72) Inventors: Nicole Viens, Bedford, NH (US); Raphael A. Rodriguez, Quincy, MA (US); Michael R. Muesch, Somerville, MA (US); Ryan Cahill, Medway, MA (US); Justin M. Boyd, Boston, MA (US); David Thor, Boston, MA (US)

(21) Appl. No.: 15/663,131

(22) Filed: Jul. 28, 2017

Related U.S. Application Data
(60) Provisional application No. 62/368,465, filed on Jul. 29, 2016.

(51) Int. Cl. G06Q 30/00; G06K 7/14

(52) U.S. Cl. CPC G06Q 30/0185; G06K 7/1413; G06K 7/1417

(57) ABSTRACT

The present disclosure describes systems and methods to classify and authenticate ID documents based on the information contained within the ID documents' 2D barcode. Different classes of ID documents can have different optional information encoded into the 2D barcode. In many cases, the card issuer does not publically document the information contained within the optional portions. The present solution can classify the ID documents based on the information contained within the required and optional portions of the 2D barcode. For example, the system can classify and authenticate the ID document based on the data encoded into the 2D barcode, the encoded data design, formatting, extra or missing encoded data, or other errors in the coding and sequencing of data encoded into the 2D barcode.

### CROSS-REFERENCE TO RELATED APPLICATIONS

The present application claims the benefit of priority to U.S. Provisional Patent Application 62/368,465, which was filed Jul. 29, 2016, and is hereby incorporated by reference in its entirety.

### BACKGROUND

The use of fake IDs is an issue in many business sectors such as underage drinking prevention, visitor management, ID retail fraud, employment authorization, etc. The fake IDs utilized today are obtainable over the internet for low cost and are remarkably close in appearance to the genuine article—even to the point that law enforcement personnel have difficulty distinguishing the real from the fake.

### BRIEF SUMMARY

The present solution disclosed herein is directed to methods and systems for authenticating identification (ID) documents. Fake IDs are an issue and have become difficult to detect by the naked eye. Fake ID producers can reproduce the data content of 2D barcodes. However, fake ID producers can have a difficult time reproducing the physical characteristics of real IDs. For example, the fake ID producers may not be able to reproduce the physical characteristics of barcodes, such as 2D barcodes in PDF-417 format. The present solution utilizes the specific production characteristics of various features on a given ID document to verify its authenticity. The present solution captures images of candidate IDs and then measures various physical characteristics of the candidate IDs. The solution automatically compares the physical characteristics from the candidate IDs to physical characteristics captured from real IDs and provides the user with a determination of whether the candidate ID is real or fake.

Additionally, the present solution can classify and authenticate ID documents based on the information contained within the ID document's 2D barcode. Different classes of ID documents can have different, optional information encoded into the 2D barcode. In many cases, the card issuer does not publically document the information contained within the optional portions. The present solution can classify the ID documents based on the information contained within the required and optional portions of the 2D barcode. In some implementations, the present solution can classify and authenticate the ID document based on the data encoded into the 2D barcode, the encoded data design, the formatting, the extra or missing encoded data, or other errors in the coding and sequencing of data encoded into the 2D barcode.

According to one aspect of the disclosure, a system to determine that a physical identification document is authentic using characteristics of the physical identification document includes an authentication manager that is executable on one or more processors. The authentication manager can be configured to receive an image of a physical identification document. The image can include a barcode of the physical identification document. The authentication manager can be configured to extract data from the barcode of the physical identification document. The authentication manager can be configured to determine a class of the physical identification document. The authentication manager can be configured to identify, based on the class of the physical identification document, an optional field in the data from the barcode. The optional field can be data that is undocumented on a face of the physical identification document. The authentication manager can be configured to generate a score based on a comparison of the optional field in the data to an optional field of a previously authenticated physical identification document of the class. The authentication manager can be configured to provide an indication that the physical identification document is authentic based on the score crossing a predetermined threshold.

The authentication manager can receive the image of the physical identification document from a remote client device. The authentication manager can be configured to determine a subclass of the physical identification document, and identify the optional field in the data based on the subclass of the physical identification document. The optional field can include at least one of incidental data or an inventory control number. The optional field can include a hash of at least one required field of the data.

The authentication manager can be configured to identify, based on the class of the physical identification document, a required field in the data, and generate the score based on the required field in the data. The authentication manager can be configured to compare data of the required field to a physical characteristic of the physical identification document. The physical characteristics can be a human readable portion of the physical identification document. The authentication manager can be configured to determine a fraudulent manufacturer of the physical identification document based on the optional field in the data.

The authentication manager can be configured to receive a second image of a second physical identification document. The second image can include a second barcode of the second physical identification document. The authentication manager can be configured to identify a required field in the data of the second barcode. The authentication manager can be configured to compare data of the required field to a physical characteristic of the second physical identification document. The authentication manager can be configured to provide an indication that the second physical identification document is fraudulent based on a mismatch between the data of the required field and the physical characteristic of the second physical identification document.

According to at least one aspect of the disclosure, a method to determine a physical identification document is authentic using characteristics of the physical identification document can include receiving, by an authentication manager, an image of a physical identification document, the image comprising a barcode of the physical identification document. The method can include extracting, by an element extraction engine executed by the authentication manager, data from the barcode of the physical identification document. The method can include determining, by the authentication manager, a class of the physical identification document. The method can include identifying, by the element extraction engine, based on the class of the physical identification document an optional field in the data. The optional field can include data that is undocumented on a face of the physical identification document. The method can include generating, by the authentication manager, a score based on a comparison of the optional field in the data to an optional field of a previously authenticated physical identification document of the class. The method can include providing, by the authentication manager, an indication that the physical identification document is authentic based on the score crossing a predetermined threshold.

In some implementations, the method can include receiving, over a network, the image of the physical identification document from a remote client device. The method can include determining, by the authentication manager, a subclass of the physical identification document, and identifying, by the authentication manager, the optional field in the data based on the subclass of the physical identification document. The optional field comprises at least one of incidental data or an inventory control number. The optional field comprises a hash of at least one required field of the data. The method can include identifying, by the element extraction engine and based on the class of the physical identification document, a required field in the data, and generating, by the authentication manager, the score based on the required field in the data.

The method can include comparing, by the authentication manager, data of the required field to a physical characteristic of the physical identification document. The physical characteristics can be a human readable portion of the physical identification document. The method can include determining, by the authentication manager, a fraudulent manufacturer of the physical identification document based on the optional field in the data.

The method can include receiving, by the authentication manager, a second image of a second physical identification document. The second image can include a second barcode of the second physical identification document. The method can include identifying, by the element extraction engine, a required field in the data of the second barcode. The method can include comparing, by the authentication engine, data of the required field to a physical characteristic of the second physical identification document. The method can include providing, by the authentication manager, an indication that the second physical identification document is fraudulent based on a mismatch between the data of the required field and the physical characteristic of the second physical identification.

### BRIEF DESCRIPTION OF THE FIGURES

The foregoing and other objects, aspects, features, and advantages of the disclosure will become more apparent and better understood by referring to the following description taken in conjunction with the accompanying drawings, in which:

FIG. 1A is a block diagram depicting an embodiment of a network environment comprising local machines in communication with remote machines;

FIGS. 1B-1D are block diagrams depicting embodiments of computers useful in connection with the methods and systems described herein;

FIG. 2 illustrates a block diagram of a system for authenticating identification (ID) documents in accordance with an implementation of the present disclosure;

FIG. 3 illustrates an example PDF-417 2D barcode in accordance with an implementation of the present disclosure;

FIGS. 4A and 4B illustrate the different height to width ratios used by different states when generating a barcode in accordance with an implementation of the present disclosure;

FIG. 5 illustrates the placement of an example barcode on an ID document in accordance with an implementation of the present disclosure;

FIG. 6 illustrates an example barcode in accordance with an implementation of the present disclosure;

FIG. 7 illustrates a block diagram of a method for authenticating an ID document in accordance with an implementation of the present disclosure; and

FIGS. 8A-8E illustrate screen shots of an instance of the authenticator application determining the authenticity of a ID document.

FIG. 9 illustrates a block diagram of a system for authenticating identification documents.

FIG. 10 illustrates an example PDF-417 barcode and the data extracted from the barcode.

FIG. 11 illustrates a block diagram of a method for authenticating an ID document.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

For purposes of reading the description of the various embodiments below, the following enumeration of the sections of the specification and their respective contents may be helpful:
Section A describes a network and computing environment which may be useful for practicing embodiments described herein; and
Section B describes embodiments of a system and method for the authentication of physical features on identification documents.
Section C describes embodiments of a system and method for the authentication of data within identification documents.

### A. Network and Computing Environment

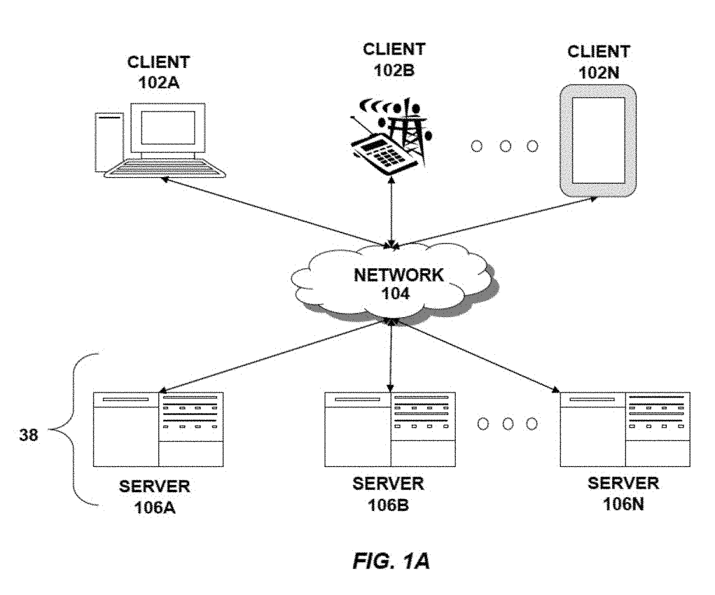

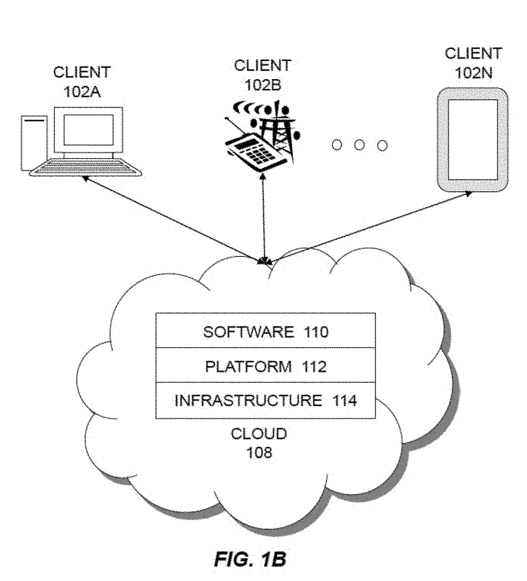

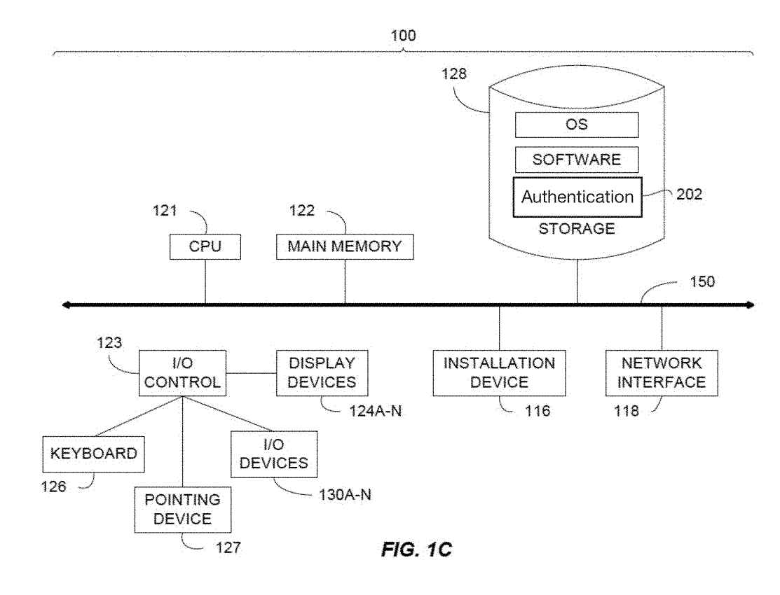

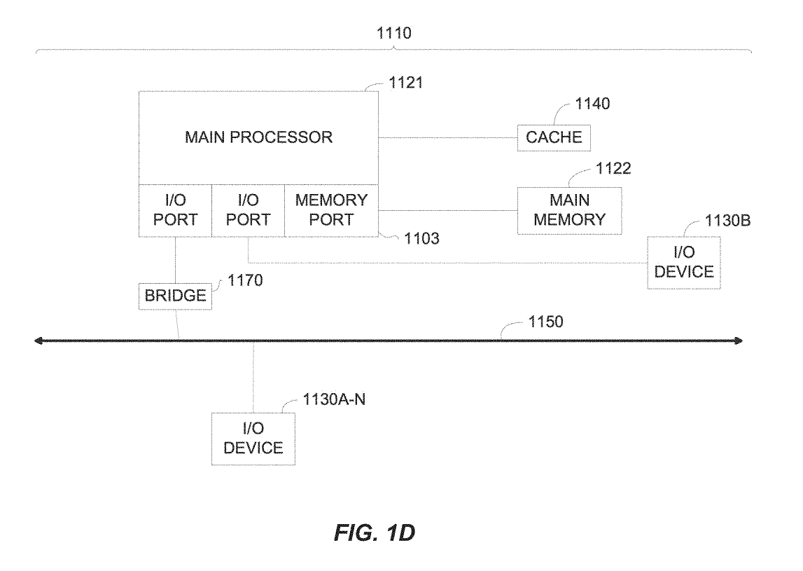

Prior to discussing the specifics of embodiments of the systems and methods, it may be helpful to discuss the network and computing environments in which such embodiments may be deployed, including a description of components and features suitable for use in the present systems and methods. FIG. 1A illustrates one embodiment of a computing environment 101 that includes one or more client machines 102A-102N (generally referred to herein as “client machine(s) 102”) in communication with one or more servers 106A-106N (generally referred to herein as “server(s) 106”). Installed in between the client machine(s) 102 and server(s) 106 is a network.

In one embodiment, the computing environment 101 can include an appliance installed between the server(s) 106 and client machine(s) 102. This appliance can manage client/server connections, and in some cases can load balance client connections amongst a plurality of backend servers. The client machine(s) 102 can in some embodiment be referred to as a single client machine 102 or a single group of client machines 102, while server(s) 106 may be referred to as a single server 106 or a single group of servers 106. In one embodiment a single client machine 102 communicates with more than one server 106, while in another embodiment a single server 106 communicates with more than one client machine 102. In yet another embodiment, a single client machine 102 communicates with a single server 106.

A client machine 102 can, in some embodiments, be referenced by any one of the following terms: client machine(s) 102; client(s); client computer(s); client device(s); client computing device(s); local machine; remote machine; client node(s); endpoint(s); endpoint node(s); or a second machine. The server 106, in some embodiments, may be referenced by any one of the following terms: server(s), local machine; remote machine; server farm(s), host computing device(s), or a first machine(s).

The client machine 102 can in some embodiments execute, operate or otherwise provide an application that can be any one of the following: software; a program; executable instructions; a virtual machine; a hypervisor; a web browser; a web-based client; a client-server application; a thin-client computing client; an ActiveX control; an Adobe Flash control (formerly called Macromedia Flash and Shockwave Flash) for production of animations, browser games, rich Internet applications, desktop applications, mobile applications and mobile games; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions. Still other embodiments include a client device 102 that displays application output generated by an application remotely executing on a server 106 or other remotely located machine. In these embodiments, the client device 102 can display the application output in an application window, a browser, or other output window. In one embodiment, the application is a desktop, while in other embodiments the application is an application that generates a desktop.

The computing environment 101 can include more than one server 106A-106N such that the servers 106A-106N are logically grouped together into a server farm 106. The server farm 106 can include servers 106 that are geographically dispersed and logically grouped together in a server farm 106, or servers 106 that are located proximate to each other and logically grouped together in a server farm 106. Geographically dispersed servers 106A-106N within a server farm 106 can, in some embodiments, communicate using a WAN, MAN, or LAN, where different geographic regions can be characterized as: different continents; different regions of a continent; different countries; different states; different cities; different campuses; different rooms; or any combination of the preceding geographical locations. In some embodiments the server farm 106 may be administered as a single entity, while in other embodiments the server farm 106 can include multiple server farms 106.

In some embodiments, a server farm 106 can include servers 106 that execute a substantially similar type of operating system platform (e.g., WINDOWS 7, 8, or 10 manufactured by Microsoft Corp. of Redmond, Wash., UNIX, LINUX, or OSX manufactured by Apple of Cupertino, Calif.) In other embodiments, the server farm 106 can include a first group of servers 106 that execute a first type of operating system platform, and a second group of servers 106 that execute a second type of operating system platform. The server farm 106, in other embodiments, can include servers 106 that execute different types of operating system platforms.

The server 106, in some embodiments, can be any server type. In other embodiments, the server 106 can be any of the following server types: a file server; an application server; a web server; a proxy server; an appliance; a network appliance; a gateway; an application gateway; a gateway server; a virtualization server; a deployment server; a SSL or IPSec VPN server; a firewall; a web server; an application server or as a master application server; a server 106 executing an active directory or LDAP; or a server 106 executing an application acceleration program that provides firewall functionality, application functionality, or load balancing functionality. In some embodiments, a server 106 may be a RADIUS server that includes a remote authentication dial-in user service. Some embodiments include a first server 106A that receives requests from a client machine 102, forwards the request to a second server 106B, and responds to the request generated by the client machine 102 with a response from the second server 106B. The first server 106A can acquire an enumeration of applications available to the client machine 102 and well as address information associated with an application server 106 hosting an application identified within the enumeration of applications. The first server 106A can then present a response to the client's request using a web interface, and communicate directly with the client 102 to provide the client 102 with access to an identified application.

Client machines 102 can, in some embodiments, be a client node that seeks access to resources provided by a server 106. In other embodiments, the server 106 may provide clients 102 or client nodes with access to hosted resources. The server 106, in some embodiments, functions as a master node such that it communicates with one or more clients 102 or servers 106. In some embodiments, the master node can identify and provide address information associated with a server 106 hosting a requested application, to one or more clients 102 or servers 106. In still other embodiments, the master node can be a server farm 106, a client 102, a cluster of client nodes 102, or an appliance.

One or more clients 102 and/or one or more servers 106 can transmit data over a network 104 installed between machines and appliances within the computing environment 101. The network 104 can comprise one or more sub-networks, and can be installed between any combination of the clients 102, servers 106, computing machines and appliances included within the computing environment 101. In some embodiments, the network 104 can be: a local-area network (LAN); a metropolitan area network (MAN); a wide area network (WAN); a primary network 104 comprised of multiple sub-networks 104 located between the client machines 102 and the servers 106; a primary public network 104 with a private sub-network 104; a primary private network 104 with a public sub-network 104; or a primary private network 104 with a private sub-network 104. Still further embodiments include a network 104 that can be any of the following network types: a point to point network; a broadcast network; a telecommunications network; a data communication network; a computer network; an ATM (Asynchronous Transfer Mode) network; a SONET (Synchronous Optical Network) network; a SDH (Synchronous Digital Hierarchy) network; GSM/UMTS/LTE networks of the Universal Mobile Telecommunications System (UMTS); a wireless network; a wireline network; or a network 104 that includes a wireless link where the wireless link can be an infrared channel or satellite band. The network topology of the network 104 can differ within different embodiments, possible network topologies include: a bus network topology; a star network topology; a ring network topology; a repeater-based network topology; or a tiered-star network topology. Additional embodiments may include a network 104 of mobile telephone networks that use a protocol to communicate among mobile devices, where the protocol can be any one of the following: AMPS; TDMA; CDMA; GSM; GPRS UMTS; 3G; 4G; or any other protocol able to transmit data among mobile devices.

Illustrated in FIG. 1B is an embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a central processing unit 121; a main memory 122; storage memory 128; an input/output (I/O) controller 123; display devices 124A-124N; an installation device 116; and a network interface 118. In one embodiment, the storage memory 128 includes: an operating system, software routines, and an authentication manager 202. The I/O controller 123, in some embodiments, is further connected to a key board 126, and a pointing device 127. Other embodiments may include an I/O controller 123 connected to more than one input/output device 130A-130N.

FIG. 1C illustrates one embodiment of a computing device 100, where the client machine 102 and server 106 illustrated in FIG. 1A can be deployed as and/or executed on any embodiment of the computing device 100 illustrated and described herein. Included within the computing device 100 is a system bus 150 that communicates with the following components: a bridge 170, and a first I/O device 130A. In another embodiment, the bridge 170 is in further communication with the main central processing unit 121, where the central processing unit 121 can further communicate with a second I/O device 130B, a main memory 122, and a cache memory 140. Included within the central processing unit 121, are I/O ports, a memory port 103, and a main processor.

Embodiments of the computing machine 100 can include a central processing unit 121 characterized by any one of the following component configurations: logic circuits that respond to and process instructions fetched from the main memory unit 122; a microprocessor unit, such as: those manufactured by Intel Corporation; those manufactured by Motorola Corporation; those manufactured by Transmeta Corporation of Santa Clara, Calif.; the RS/6000 processor such as those manufactured by International Business Machines; a processor such as those manufactured by Advanced Micro Devices; or any other combination of logic circuits. Still other embodiments of the central processing unit 122 may include any combination of the following: a microprocessor, a microcontroller, a central processing unit with a single processing core, a central processing unit with two processing cores, or a central processing unit with more than one processing core.

While FIG. 1C illustrates a computing device 100 that includes a single central processing unit 121, in some embodiments the computing device 100 can include one or more processing units 121. In these embodiments, the computing device 100 may store and execute firmware or other executable instructions that, when executed, direct the one or more processing units 121 to simultaneously execute instructions or to simultaneously execute instructions on a single piece of data. In other embodiments, the computing device 100 may store and execute firmware or other executable instructions that, when executed, direct the one or more processing units to each execute a section of a group of instructions. For example, each processing unit 121 may be instructed to execute a portion of a program or a particular module within a program.

In some embodiments, the processing unit 121 can include one or more processing cores. For example, the processing unit 121 may have two cores, four cores, eight cores, etc. In one embodiment, the processing unit 121 may comprise one or more parallel processing cores. The processing cores of the processing unit 121 may in some embodiments access available memory as a global address space, or in other embodiments, memory within the computing device 100 can be segmented and assigned to a particular core within the processing unit 121. In one embodiment, the one or more processing cores or processors in the computing device 100 can each access local memory. In still another embodiment, memory within the computing device 100 can be shared amongst one or more processors or processing cores, while other memory can be accessed by particular processors or subsets of processors. In embodiments where the computing device 100 includes more than one processing unit, the multiple processing units can be included in a single integrated circuit (IC). These multiple processors, in some embodiments, can be linked together by an internal high speed bus, which may be referred to as an element interconnect bus.

In embodiments where the computing device 100 includes one or more processing units 121, or a processing unit 121 including one or more processing cores, the processors can execute a single instruction simultaneously on multiple pieces of data (SIMD), or in other embodiments can execute multiple instructions simultaneously on multiple pieces of data (MIMD). In some embodiments, the computing device 100 can include any number of SIMD and MIMD processors.

The computing device 100, in some embodiments, can include an image processor, a graphics processor or a graphics processing unit. The graphics processing unit can include any combination of software and hardware, and can further input graphics data and graphics instructions, render a graphic from the inputted data and instructions, and output the rendered graphic. In some embodiments, the graphics processing unit can be included within the processing unit 121. In other embodiments, the computing device 100 can include one or more processing units 121, where at least one processing unit 121 is dedicated to processing and rendering graphics.

One embodiment of the computing machine 100 includes a central processing unit 121 that communicates with cache memory 140 via a secondary bus also known as a backside bus, while another embodiment of the computing machine 100 includes a central processing unit 121 that communicates with cache memory via the system bus 150. The local system bus 150 can, in some embodiments, also be used by the central processing unit to communicate with more than one type of I/O device 130A-130N. In some embodiments, the local system bus 150 can be any one of the following types of buses: a VESA VL bus; an ISA bus; an EISA bus; a MicroChannel Architecture (MCA) bus; a PCI bus; a PCI-X bus; a PCI-Express bus; or a NuBus. Other embodiments of the computing machine 100 include an I/O device 130A-130N that is a video display 124 that communicates with the central processing unit 121. Still other versions of the computing machine 100 include a processor 121 connected to an I/O device 130A-130N via any one of the following connections: HyperTransport, Rapid I/O, or InfiniBand. Further embodiments of the computing machine 100 include a processor 121 that communicates with one I/O device 130A using a local interconnect bus and a second I/O device 130B using a direct connection.

The computing device 100, in some embodiments, includes a main memory unit 122 and cache memory 140. The cache memory 140 can be any memory type, and in some embodiments can be any one of the following types of memory: SRAM; BSRAM; or EDRAM. Other embodiments include cache memory 140 and a main memory unit 122 that can be any one of the following types of memory: Static random access memory (SRAM), Burst SRAM or SynchBurst SRAM (BSRAM); Dynamic random access memory (DRAM); Fast Page Mode DRAM (FPM DRAM); Enhanced DRAM (EDRAM), Extended Data Output RAM (EDO RAM); Extended Data Output DRAM (EDO DRAM); Burst Extended Data Output DRAM (BEDO DRAM); Enhanced DRAM (EDRAM); synchronous DRAM (SDRAM); JEDEC SRAM; PC100 SDRAM; Double Data Rate SDRAM (DDR SDRAM); Enhanced SDRAM (ESDRAM); SyncLink DRAM (SLDRAM); Direct Rambus DRAM (DRDRAM); Ferroelectric RAM (FRAM); or any other type of memory. Further embodiments include a central processing unit 121 that can access the main memory 122 via: a system bus 150; a memory port 103; or any other connection, bus or port that allows the processor 121 to access memory 122.

One embodiment of the computing device 100 provides support for any one of the following installation devices 116: a CD-ROM drive, a CD-R/RW drive, a DVD-ROM drive, tape drives of various formats, USB device, a bootable medium, a bootable CD, a bootable CD for GNU/Linux distribution such as KNOPPIX®, a hard-drive or any other device suitable for installing applications or software. Applications can in some embodiments include identification (ID) authentication software 120. The computing device 100 may further include a storage device 128 that can be either one or more hard disk drives, or one or more redundant arrays of independent disks; where the storage device is configured to store an operating system, software, programs applications, or at least a portion of the identification (ID) authentication software 120. A further embodiment of the computing device 100 includes an installation device 116 that is used as the storage device 128.

The computing device 100 may further include a network interface 118 to interface to a Local Area Network (LAN), Wide Area Network (WAN) or the Internet through a variety of connections including, but not limited to, standard telephone lines, LAN or WAN links (e.g., 802.11, T1, T3, 56kb, X.25, SNA, DECNET), broadband connections (e.g., ISDN, Frame Relay, ATM, Gigabit Ethernet, Ethernet-over-SONET), wireless connections, or some combination of any or all of the above. Connections can also be established using a variety of communication protocols (e.g., TCP/IP, IPX, SPX, NetBIOS, Ethernet, ARCNET, SONET, SDH, Fiber Distributed Data Interface (FDDI), RS232, RS485, IEEE 802.11, IEEE 802.11a, IEEE 802.11b, IEEE 802.11g, CDMA, GSM, WiMax and direct asynchronous connections). One version of the computing device 100 includes a network interface 118 able to communicate with additional computing devices 100′ via any type and/or form of gateway or tunneling protocol such as Secure Socket Layer (SSL) or Transport Layer Security (TLS), or the Citrix Gateway Protocol manufactured by Citrix Systems, Inc. Versions of the network interface 118 can comprise any one of: a built-in network adapter; a network interface card; a PCMCIA network card; a card bus network adapter; a wireless network adapter; a USB network adapter; a modem; or any other device suitable for interfacing the computing device 100 to a network capable of communicating and performing the methods and systems described herein.

Embodiments of the computing device 100 include any one of the following I/O devices 130A-130N: a keyboard 126; a pointing device 127; mice; trackpads; an optical pen; trackballs; microphones; drawing tablets; video displays; speakers; inkjet printers; laser printers; and dye-sublimation printers; or any other input/output device able to perform the methods and systems described herein. An I/O controller 123 may in some embodiments connect to multiple I/O devices 103A-130N to control the one or more I/O devices. Some embodiments of the I/O devices 130A-130N may be configured to provide storage or an installation medium 116, while others may provide a universal serial bus (USB) interface for receiving USB storage devices such as the USB Flash Drive line of devices manufactured by Twintech Industry, Inc. Still other embodiments include an I/O device 130 that may be a bridge between the system bus 150 and an external communication bus, such as: a USB bus; an Apple Desktop Bus; an RS-232 serial connection; a SCSI bus; a FireWire bus; a FireWire 800 bus; an Ethernet bus; an AppleTalk bus; a Gigabit Ethernet bus; an Asynchronous Transfer Mode bus; a HIPPI bus; a Super HIPPI bus; a SerialPlus bus; a SCI/LAMP bus; a FibreChannel bus; or a Serial Attached small computer system interface bus.

In some embodiments, the computing machine 100 can execute any operating system, while in other embodiments the computing machine 100 can execute any of the following operating systems: versions of the MICROSOFT WINDOWS operating systems; the different releases of the Unix and Linux operating systems; any version of the MAC OS manufactured by Apple Computer; OS/2, manufactured by International Business Machines; Android by Google; any embedded operating system; any real-time operating system; any open source operating system; any proprietary operating system; any operating systems for mobile computing devices; or any other operating system. In still another embodiment, the computing machine 100 can execute multiple operating systems. For example, the computing machine 100 can execute PARALLELS or another virtualization platform that can execute or manage a virtual machine executing a first operating system, while the computing machine 100 executes a second operating system different from the first operating system.

The computing machine 100 can be embodied in any one of the following computing devices: a computing workstation; a desktop computer; a laptop or notebook computer; a server; a handheld computer; a mobile telephone; a portable telecommunication device; a media playing device; a gaming system; a mobile computing device; a netbook, a tablet; a device of the IPOD or IPAD family of devices manufactured by Apple Computer; any one of the PLAYSTATION family of devices manufactured by the Sony Corporation; any one of the Nintendo family of devices manufactured by Nintendo Co; any one of the XBOX family of devices manufactured by the Microsoft Corporation; or any other type and/or form of computing, telecommunications or media device that is capable of communication and that has sufficient processor power and memory capacity to perform the methods and systems described herein. In other embodiments the computing machine 100 can be a mobile device such as any one of the following mobile devices: a JAVA-enabled cellular telephone or personal digital assistant (PDA); any computing device that has different processors, operating systems, and input devices consistent with the device; or any other mobile computing device capable of performing the methods and systems described herein. In still other embodiments, the computing device 100 can be any one of the following mobile computing devices: any one series of Blackberry, or other handheld device manufactured by Research In Motion Limited; the iPhone manufactured by Apple Computer; Palm Pre; a Pocket PC; a Pocket PC Phone; an Android phone; or any other handheld mobile device. Having described certain system components and features that may be suitable for use in the present systems and methods, further aspects are addressed below.

### B. System and Method for Authentication of Physical Features on Identification Documents

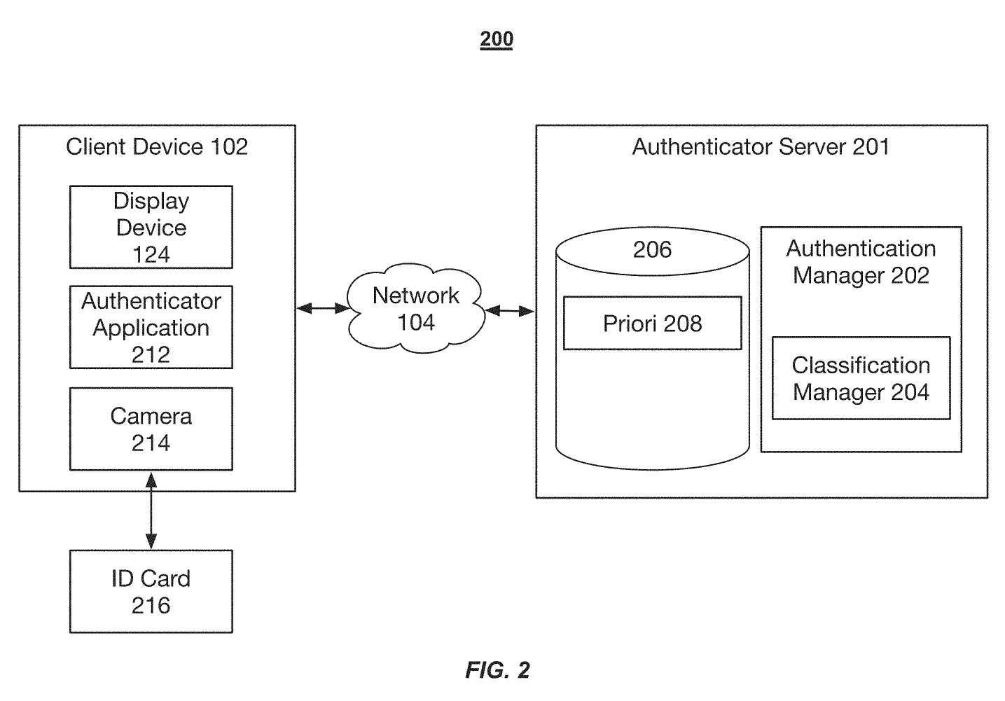

Referring to FIGS. 2-8E, the systems and methods of the architecture, process and implementation of ID document authentication will be described. In general, the present disclosure discusses a solution for automatically authenticating ID documents, such as driver's license and other government (and non-government) supplied IDs. A client device of the system can be configured to operate on smartphones, tables, and other mobile devices. The client device can capture an image of a candidate ID and upload the image to an authentication server of the system. The server can process the image to extract physical characteristics of the ID document. In some implementations, the server extracts physical characteristics of one or more objects or patterns on a face of the ID document, such as a barcode. The server can analyze the extracted physical characteristics and compare the extract characteristics against a database of characteristics extracted from known valid ID documents. Based on the comparison, the server can make a determination of whether the ID document is fake and return the result to the client device.

FIG. 2 illustrates a block diagram of a system 200 for authenticating identification documents. The system 200 can include a client device 102 that is in communication with an authentication server 201 via a network 104. The authentication server 201 executes at least one instance of an authentication manager 202. The authentication manager 202 includes a classification manager 204. The authenticator server 201 also includes a database 206 that stores a data structure of priori knowledge sets 208 that are used to analyze IDs 216.

The system 200 can also include one or more client devices 102. Each client device 102 executes an instance of the authenticator application 212. Each client device 102 may include a camera 214 for scanning or otherwise reading an ID document 216 (also referred herein as ID cards), and a display device 124 for presenting or displaying a copy of the scanned ID card and authentication results. In some implementations, the authenticator application 212 can perform part or all of the authentication analysis described herein. In other implementations, the authenticator application 212 can transmit a copy of the scanned ID to the authenticator server 201, which can analyze the image and can return a result to the client device 102 and authenticator application 212.

Each and/or any of the components of the authenticator server 201 and authenticator application 212 may include or be implemented as one or more applications, programs, libraries, scripts, services, processes, tasks and/or any type and form of executable instructions executing on one or more devices or processors.

The client device 102 is configured to captured an image of the ID card in some electronic manner. For example, if the client device 102 is a smartphone with a built in camera, the authenticator application 212 can use the smartphone's camera to capture an image of the ID card. In other implementations, the client device 102 can couple to another device such as a stand alone still or video camera or scanning device to capture images of the ID card. The original image of the ID card captured may be larger than the ID card 216 (e.g., include unnecessary background portions) and the ID card may be extracted from the original image. For example, the background or other parts of the image that are not part of the ID card may be automatically or manually removed. This process may involve some image processing such as rotation, deskewing, cropping, resizing, and image and lighting correction to obtain a proper orthogonal image with the proper aspect ratio for the document type in question.

In some implementations, the authentication manager 202 is configured to conduct a training phase where physical features of known real IDs are determined by a measurement process. For example, physical characteristics relevant for 2D barcodes can include location, size, and aspect ratio of barcode and barcode elements, number of groups, rows, columns, specific state security features, encryption markers, or any combination thereof are captured and analyzed from known real IDs. These features are stored for further use in an authentication phase as priori knowledge sets 208 in the database 206. In some implementations, the priori knowledge sets 208 are updated as the system 200 scans and analyzes additional ID cards 216.

As further described below, the client device 102 and the authenticator server 201 can then be used to authenticate ID cards 216. As an overview, a candidate ID216 card is captured as an image via the camera 214 and transmitted to the authenticator server 201, which can determine a degree of confidence that the ID card 216 is real. The authenticator server 201 can derive a set of features based on physical characteristics that can include characteristics of a 2D barcode on the ID card 216. The image is classified as to type by the classifier manager 204 and its specific type is determined. For authentication, the features (e.g. those from the 2D barcode) are compared to features for reals IDs (obtained in the training phase) for that specific ID type. Differences between the candidate and real feature sets are computed, and the difference is used to calculate a confidence level that the ID is genuine. A threshold can be used with this confidence level to determine if the ID will pass or fail.

The use of fake IDs is a large issue in many business sectors such as underage drinking prevention, visitor management, ID retail fraud, employment authorization, etc. The fake IDs utilized today are obtainable over the internet for low cost and are remarkably close in appearance to the genuine article—even to the point that law enforcement personnel have difficulty distinguishing the real from the fake.

Compounding the problem is the huge variety of government IDs that are issued. For instance, each state has a distinctive design and information layout. Commonly there are multiple design varieties from the same issuer in circulation simultaneously. In addition, within a particular ID issue, there are multiple types such as driver's licenses, identification cards, learner permits, commercial licenses, and usually vertical format license for those under 21 years of age (in the US). Each type of license may incorporate different and varied types of security features.

Thus, anyone inspecting an ID has a difficult task—even if they have received specialized training. Often, the ID checker is under pressure to process the ID quickly. If done manually, they may utilize magnifiers or special lighting (e.g. UV) to do a better job at examining some of the security features embedded in the IDs. But careful human inspection of IDs can be slow and subject to error. To assist in the process, over the years, specialized equipment has been developed to help automate the inspection process. The technology described herein can find use in such automated authentication systems to help identify false documents.

Organizations such as the American Association of Motor Vehicle Administrators (AAMVA) have issued standards for ID layout, information formats, and suggested security features. In the US, the REAL-ID Act has helped to push ID issuers in the US to produce licenses produced under more secure conditions and with more security features. However, fake ID producers have also gotten much more sophisticated in duplicating the security features on real IDs including holograms, ultraviolet features, ghost images, microprint, laser perforation, raised printing, variable font-size printing, kinegrams, and barcodes.

Barcode scanners use a number of technologies from using a scanning laser to capture of the image and reading with software. But the basic idea is to convert the barcode into a text string. For certain applications such as license reading, the task is then to parse out this string into fields such as name, address, and other relevant information about the person located on the front of the ID that is readable to the naked eye alongside their photo.

In the early days of fake ID's it was difficult to generate a PDF-417 barcode with the correct info. Comparing the barcode info to the front of the ID info was often an effective technique for fake detection. For driver's licenses in the US and Canada, there is an AAMVA standard that makes recommendations on the layout, header information, fields, delimiters, etc. and specifies the precise format of the barcode information. Even with standardization, different issuers include different information and in different order. The standard is a two edged sword—making available the format to those who wish to duplicate it. Barcode generators are now readily available even online to generate a credible looking 2D barcode that is scan-able with most barcode readers. Such a barcode will decode into a legal text string and likely into acceptable parsed data fields.

The current generations of fake IDs have credible printing and color matching, holograms, UV features, and barcodes that scan similar to real IDs. Fake ID producers even advertise their product as being able to “pass barcode scanning.” The ability to be scanned successfully is no longer sufficient to detect fake IDs. This has spawned an era of newer “reader-authenticators” which are based on high resolution imaging of both the front and back of the ID. In this case, the barcode could be decoded from the image rather than from the traditional technique of laser scanning.

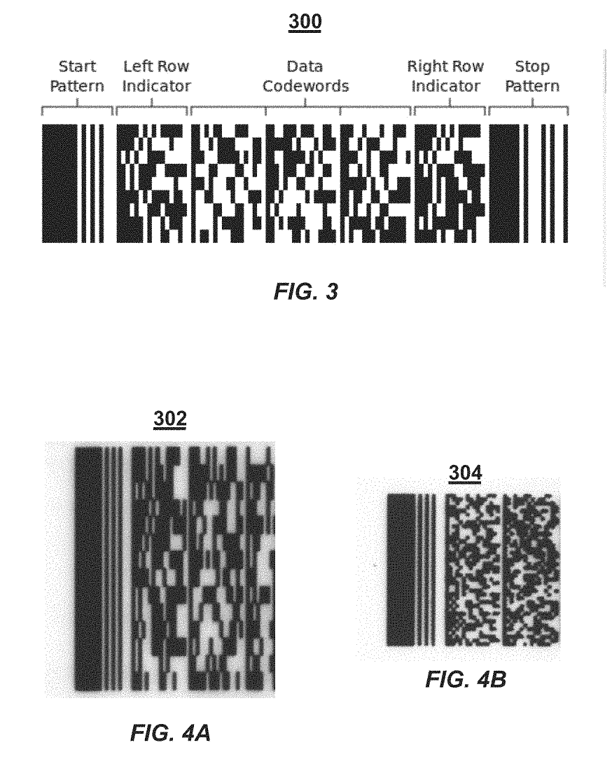

In some implementations, the ID card 216 can include a barcode, such as a PDF-417 barcode. The PDF-417 2D barcode format has been adopted as the standard format for machine readable data in US and Canada driver's licenses and indeed for most of the ID-1 sized cards in the world. This format has the advantages of being able to contain a lot of data, has redundancy in case part of the code is damaged or dirty, and can be read with a variety of devices including laser and image based scanners. FIG. 3 illustrates an example PDF-417 2D barcode 300.

The PDF-417 is 2D a stacked barcode symbology and has become the default standard for encoding information on US driver's licenses. The barcode can include of linear rows of stacked code words. The nomenclature PDF-417 (Portable Data File 417) comes from the fact that each code word consists 4 black bars and 4 white spaces of varying lengths within a horizontal grid of 17 positions. There can be from 3 to 90 rows, and each row can be considered a kind of linear 1D barcode. Within a row, there can be from 1 to 30 code words. No two successive rows are the same except for within the start and stop patterns.

The minimal element in a code word is a module, which is the grid element in a row within the 17 columns of the code word. There is a recommendation that the module's height be 3 times its width. However, different barcode issuers utilize different height to width ratios in their barcodes and this sometimes results in perceptually different looking barcodes. See the two examples below which have very different overall and element sizes. For example, FIGS. 4A and 4B illustrate the different height to width ratios used by different states. FIG. 4A illustrates a portion 302 of a PDF-417 barcode from a South Carolina driver's license and FIG. 4B illustrates a portion 304 of a PDF-417 barcode from a Mississippi driver's license.

While, in some situations, the size of a black module would be the same size as a white module, this does not always hold true. In some cases, the quality of the printing is an important factor affected by the type of printer, printer supplies, temperature of the print head, etc. This variability can lead to black ink bleed or shrinkage and lead to wider black space elements and thus narrower white space elements and vice versa. Most barcode readers try to deal with this element of variability.

The first element in a given code word is always black (the beginning element of the first of four bars in the code word) and the last element in a code word is always white (the end element of the last of four spaces in the code word). This property makes the divisions between code words fairly visible to the eye. The sets for code words stacked vertically may be referred to as a group. The number of groups varies with how the barcode is generated but can be somewhat controlled via the input parameters to the barcode generator.

A PDF-417 barcode always begins with a fixed start pattern and ends with a fixed, but different, stop pattern. The start pattern might be considered a fixed group since it is generally the same width as the code word groups and consists of 4 bars and 4 spaces just like the other code words. The start pattern is the same in all rows. The stop pattern is similar to the start pattern but has one extra minimal width bar at the end. The start and stop patterns allow the reader to determine the orientation of the barcode easily.

The left row indicator group may not contain the actual text encoded in the barcode but rather other parameters such as the number of rows and columns, etc. in the barcode. The right row indicator may also not contain the actual text.

The number of code words on a line can be set at generation time. There are also different compaction modes, and different correction levels. Depending on the number of code words across (groups), the type of compaction, and the correction levels chosen, the actual 2D printed barcode can look quite different even though the actual encoded string is identical.

The actual physical position of the barcode on an ID card is one example of a physical characteristic and is substantially consistent within the same issuer (e.g., a state's division of motor vehicles). In US IDs, the barcode is printed on the back of the ID. AAMVA standards have recommendations for barcode placement and size, but there is considerable variability among issuers. The back of IDs is generally less colorful than the front and thus less potential interference with the variable material printed in black ink there such as a 2D barcode. Blank cards may already have a design printed on them, and the variable information is printed in a separate pass. Some issuers may print the variable information on an overlay or cover the printed information with an overlay.

The barcode height and width are also generally fixed within a given issuer. Some issuers, during the same general issued series (on the front of the ID), have decided to include more information in the barcode on the back and thus there may be multiple sizes of barcodes issued within the same series. One example of this is the Massachusetts 2010 series where IDs issued past a certain date were of a larger size.

While forgers have easy access to 2D barcode generators for the PDF-417 symbology, unless they choose the exact same parameters in all these dimensions as used in the real document, the barcode will vary somewhat physically in appearance from a genuine document.

While the examples provided herein detect false IDs based on the physical characteristics of barcodes, such as the PDF-417 barcode standard, any other type of barcode may be used (e.g. Code 39, Code 128, and others), as well as other fixed and variable type patterns found on the front or back of IDs. The difference between conventional authentication techniques, which use methods such as pattern matching to verify the presence of a feature, and this concept is the focus on the relationships between physical elements resulting from the ID issuers unique production process.

In some implementations, the authentication manager 202 can measure certain characteristics of an ID or section of the ID and perform a comparison of those characteristics with characteristics from a genuine ID. The authentication manager 202 can select appropriate and measurable characteristics that are capable of distinguishing real from fake IDs. The strength of the characteristics can vary quite a bit and can depend on how easy or difficult it is for the false document supplier to recognize specific properties and then to recreate the characteristics of the genuine document. It may be easy to create a false document that has the general look and feel of a real document but a suitably designed automatic detection schema can be designed to pick up much more subtle differences that could pass mere human inspection.

In some implementations, the authentication manager 202 can include a classification manager that can determine the class of ID card presented to the system 200. For example, as each US state issues different ID cards, the classification can indicate from which state the ID card was issued. After classifying the ID card's state, the ID card may be sub-classified. For example, states may issue driver's licenses, ID cards, learner's permits, etc.—each of which could be a different subclass under the state's classification. In some implementations, the ID card can be classified into one or more of 410 different document classes in the US in an ID1 format. Classifying the ID card can help the authentication manager 202 select those characteristics that provide the best information for determining the validity of the ID card. The physical characteristics of barcodes (e.g., overall size, location, element size, rows and columns, etc.) vary between different issuers (and thus different classification). These characteristics can be used as features to determine or narrow down the ID type by matching these features against the standard features across all classes to determine a best match or small set of potential matches. By classifying an unknown document to a particular class, it provides a great advantage since the authentication manager can look up the correct features to expect for that particular document. If the document features (e.g. barcode characteristics) are not close enough to the real document, then the authentication manager can determine or judge the document to be not sufficiently close to be accepted as a real document or possibly an altered document.

The authentication manager 202 can also measure certain physical characteristics of the barcode on the ID card and treat the characteristics as features. The features can be compared to the corresponding feature characteristics of genuine (e.g., known valid) documents and known fake documents to make a determination as to whether the unknown document's features are closer to the real or the fake set of features.

The authentication manager 202 can analyze one or more characteristics of the ID card to determine the validity of the ID card. False documents typically will have characteristics that will not match real documents in one or more of the following features. The features can include the physical location and size of the barcode on the ID. This feature can use an ID document's conformance to established size standards (ID1, ID2, . . . ) to help make a determination as to the document's validity. Given this knowledge, the DPI value can be determined from the image and used as a ruler to locate, measure distance, scale, and size. 2D barcodes will generally be of fixed width and height. It is possible however for an issuer to modify the size within a particular issue—if they decide to add more information fields. For example, Massachusetts has two different barcode heights within the same issue. Fake barcodes will often not be the correct size or in the exact correct location.

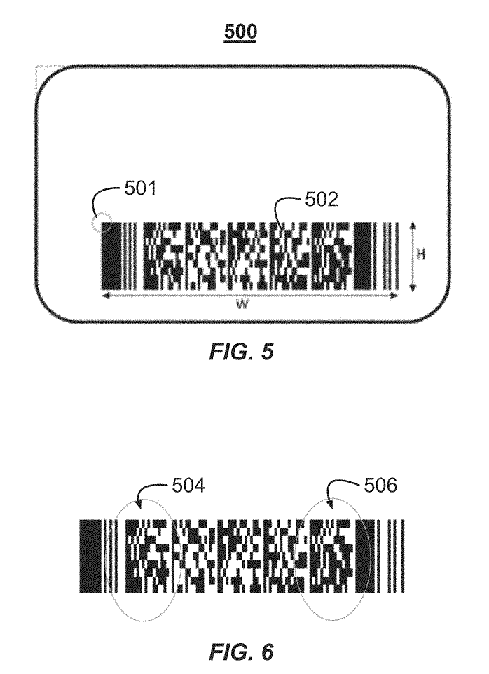

To derive these features, measure the physical location and/or size of the barcode in pixel units. For example, and referring to FIG. 5, the X,Y location 501 relative to the edge or corner of the document or relative to some other fixed anchor point can be found, and then the size (height and width) of the barcode 502 can be measured. Given the (dots per inch) DPI of the image, these measurements can be converted into physical units such as inches or millimeters. Comparisons, made in physical units, result in resolution independence.

Another characteristic can be the height to width ratio of the barcode. The measure of the ratio of the height to width of the barcode can be referred to as the aspect ratio of the barcode. This feature can be size invariant but can depend on having an image capture process that will generate an image with the correct overall aspect ratio for the document.

Another characteristic can be the number of code groups horizontally in a barcode. This is related to the number of columns for the 2D barcodes. A related characteristic can be the number of columns horizontally in a barcode. Generally, this can be related to the number of code words since there are a fixed number of module elements within a horizontal code group for PDF-417 barcodes. Each code group can include of 17 elements.

Another characteristic can be the number of rows in a barcode. This is a characteristic that is often gotten wrong by forgers. By creating a table of rows and columns for known ID types, this can be used for comparison for candidate IDs.

Another characteristic can be the module element size. The module element is the smallest barcode element and can be either a white or black module. White and black modules can have different measured sizes due to printer variations and dye/ink characteristics.

Another characteristic can be the ratio of black and white module element sizes. A valid barcode does not necessarily have the same size black and white module sizes due to printer variations and dye/ink transfer characteristics.

In some implementations, the smallest elements in a 2D barcode can have a fixed aspect ratio and size. As stated, the size of the smallest black elements and white elements may also vary from each other due to the type of printer, printer element temperature or other factors, and the relative size may also be a distinguishing characteristic, if stable for that type of ID. The height to width ratio of the smallest module element size is supposed to be on the order of 3 to 1. However, this ratio varies substantially for different IDs. As seen in the earlier example, the ratio varies from approximately 5-1 for South Carolina to 1-1 for Mississippi. Hence, it becomes a distinguishing property for that Issuer.

Additional data encoded in the barcode can also be used as characteristics for analyzing the validity of the ID card. The barcode can include data that is not related to the owner of the ID card. This data can include an encryption level, size of the barcode, number of rows and columns, and row and column information, and other characteristics.

In some implementations, the authentication manager 202 can use template matching to make physical measurements of the many characteristics described above. For instance, a template match of the upper left corner and lower right corner of a barcode can be used to determine the size of the barcode. Either corner could be used to define the location.

A count of average gray value for each horizontal position and subsequent peak detection can be used to determine the number of groups horizontally. Histogram analysis can be used to measure rows and modules.

Pattern matching can also be used by the authentication manager 202 to determine if patterns in the barcode match expected codes. For example, and also referring to FIG. 6, because the left most PDF-417 group 504 can contain some of the basic encoding features (e.g. row and column information), and not the actual data, the pattern for this group is can constant across IDs of a given classification. A pattern match done on just this first group could detect fake IDs that do not encode the barcode correctly. Likewise, and also referring to FIG. 6, the Right Row Indicator 506 can normally remain constant within a particular document class and pattern matching on this element could be used as a feature.

Filler data in the barcode can also be used by the authenticator manager 202 as a characteristic. In some 2D barcodes, there are areas with repeating code words that are used as filler data. This comes about due to the variable amount of data encoded into a given barcode combined with the need to maintain a fixed physical size of barcode as well as number of rows and columns. A pattern match on the filler code word patterns to see if they match those found on real IDs could be used as a feature.

In some implementations, the decoding process can be used as a characteristic. The decoder can know predetermined information about the barcode to enable the decoder to decode the barcode. If the barcode reader detects deviation from the expected values, those deviations can be used as characteristics.

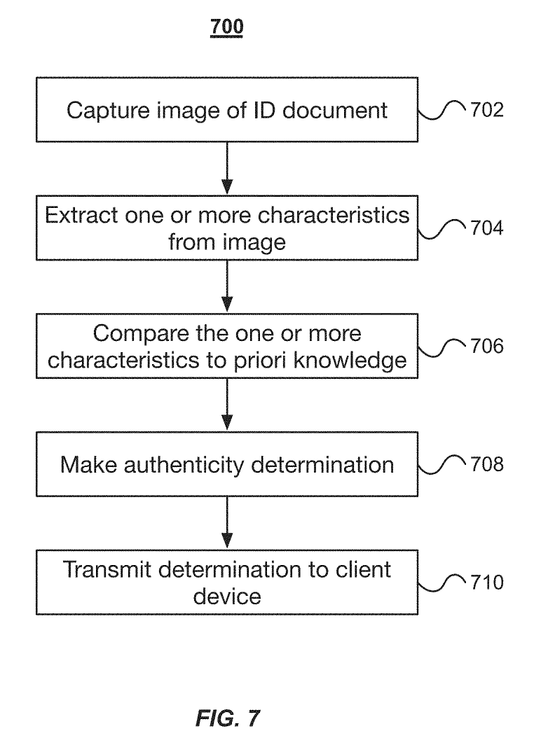

FIG. 7 illustrates a block diagram 700 of a method for authenticating an ID document. The method can include capturing an imaging of an ID document (BLOCK 702). The method can include extracting one or more characteristics from the image of the ID document (BLOCK 704). The one or more characteristics can then be compared against priori knowledge (BLOCK 706), and an authenticity determination can be made (BLOCK 708). The authenticity determination can be transmitted to a client device for display (BLOCK 710).

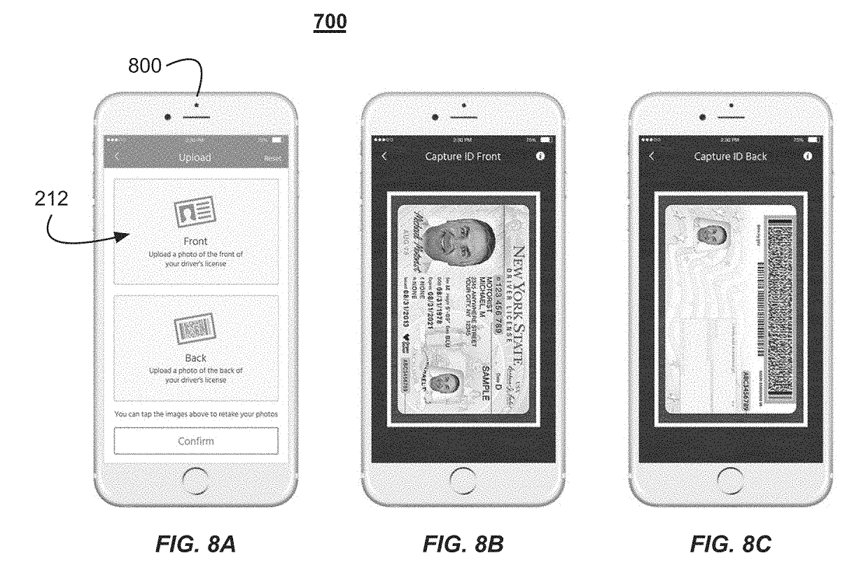

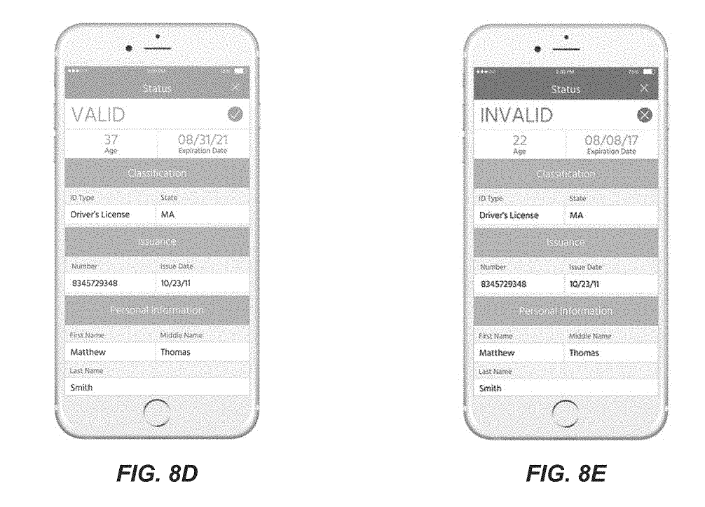

As set forth above, the method can include capturing an image of an ID document (BLOCK 702). The image of the ID document can be captured by a client device. For example, the authenticator application discussed above can be executed by a smartphone or tablet computer. The authenticator application can use the smartphone's built in camera to capture an image of the ID document. For example, and also referring to FIGS. 8A-8C, a smartphone 800 can execute an instance of the authenticator application 212, which can present the user with a prompt to capture an image of the front and back of an ID document. FIG. 8B illustrates the user capturing the front of the ID document and FIG. 8C illustrate the user capturing the back of the ID document. As illustrated in FIGS. 8B and 8C, and described above, the authenticator application 212 can remove the background and other portions of the images from the captured image to leave substantially only the ID document in the captured image. The authenticator application 212 can also rotate, deskew, and otherwise correct the captured image to prepare the image for processing.

The method can also include extracting one or more characteristics from the captured image (BLOCK 704). In some implementations, the characteristics are extracted by the authenticator application 212 executing on the client device. In other implementations, the client device can transmit the image to a remote server, e.g., the authenticator server, where the characteristics are extracted by an authentication manager. The extracted characteristics can be any of the characteristics described herein. In some implementations, the authentication manager can classify the captured ID document and determine to which class and subclass the ID belongs. Based on the classification, the authentication manager may select predetermined characteristics from the captured image. For example, after classifying the ID document as a driver's license from Ohio, the authentication manager may reference a lookup table to determine which characteristics are most beneficial to use in determining the validity of an Ohio driver's license and then extract those characteristics form the image.

The method can then compare the extracted characteristics to priori knowledge (BLOCK 706). The authentication manager can include a machine learning algorithm that is configured to determine whether the extracted characteristics match those extracted from known valid ID documents. The method can include making an authenticity determination (BLOCK 708) based on the comparison. In some implementations, the determination is binary and returns a VALID or INVALID determination. In other implementations, the authenticity determination may be a range indicating the likelihood the ID document is valid. The range can range from 0% (e.g., not valid) to 100% (valid). The range may be include a threshold (e.g., 75%) over which the document is determined valid or likely valid.

The method can also include transmitting the determination to the client device (BLOCK 710). FIGS. 8D and 8E illustrate example results of the determination being transmitted back to the client device. FIG. 8D illustrates the authenticator application displaying a valid determination after determining a presented ID document is valid. As illustrated, the authenticator application can also display additional information, such as the classification and personal information either determined by the authenticator server or extracted from the barcode on the ID card. FIG. 8E illustrates an example of the authenticator application displaying an invalid determination.

C. System and Method for Authentication of Data within Identification Documents.

In addition to authenticating an ID document based on the extracted physical characteristics of the ID document (as described above), the present solution can also classify and authenticate ID documents based on data contained within the ID document's barcodes. Many ID documents, such as driver's licenses, can include barcodes that follow the AAMVA specification. The AAMVA specification sets forth the size and organization of the fields encoded within the barcode found on the ID document. The AAMVA specification includes a number of required fields, such as first and last name of the ID document owner. The AAMVA specification also includes a number of optional fields. The data contained within the optional fields is often undocumented by states and other issuing agencies, making it more difficult to accurately replicate the data stored within these fields. The present disclosure describes a system and method that can analyze the data stored within the required and optional fields to classify and authenticate ID documents.

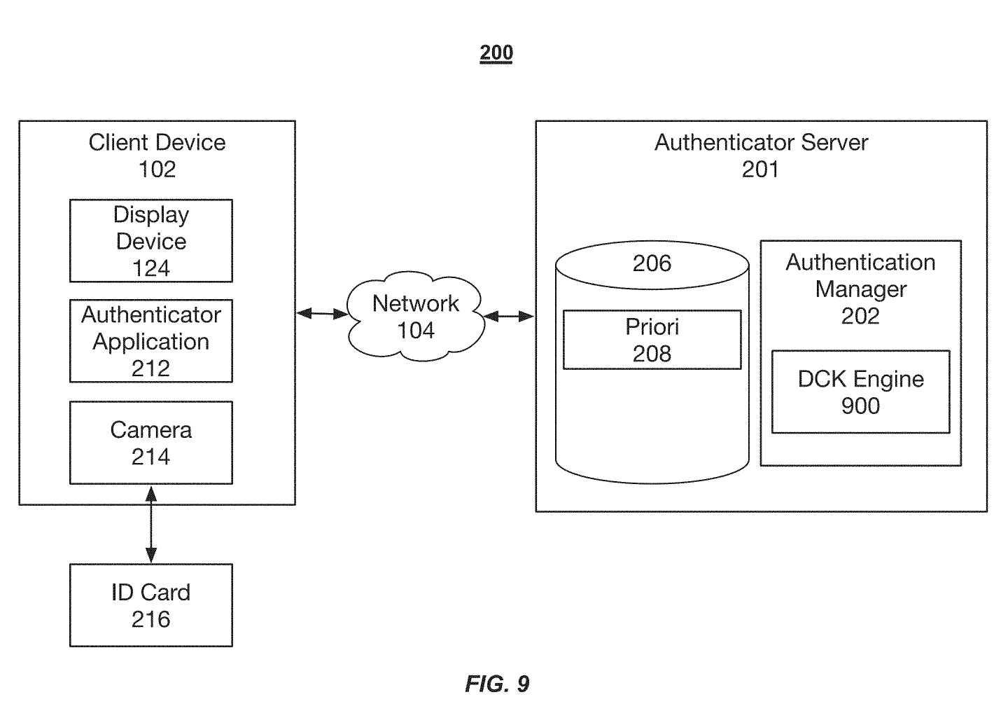

FIG. 9 illustrates a block diagram of a system 200 for authenticating identification documents. The system 200 can include a client device 102 that is in communication with an authentication server 201 via a network 104. The authentication server 201 executes at least one instance of an authentication manager 202. The authentication manager 202 includes a DCK engine 900. The authenticator server 201 also includes a database 206 that stores a data structure of priori knowledge sets 208 that are used to analyze IDs 216 (e.g., the authenticator server 201 can compare the features to priori knowledge sets 208 for the determined class). The system 200 is similar to the system 200 described above and can include any of the components described above in Section B.

In addition to the above described components, the system 200 can include a DCK engine 900. The DCK engine 900 can classify and authenticate ID documents based on data contained within the barcodes, such as a PDF-417 2D barcode, on the face of the ID documents. In some implementations, the accuracy of authenticating an ID document is increased by first classifying an unknown ID document to a particular class before performing the above described authentication process. The classes can include different classes for each state, year, issuing agency, or other organizational hierarchy. Each class can also include subclasses. For example, a driver's license subclass, a learner's permit subclass, and an identification document subclass. Classifying the ID document into a class (and subclass) can increase the accuracy because the authenticator server 201 can analyze and compare specific features of the unknown ID document to the corresponding features of ID documents within the matching class know to be authentic. For example, the DCK engine 900 can determine the unknown ID document is within the class of Massachusetts identification documents and the subclass of a learner's permit. The authenticator server 201 can then compare the unknown ID document to priori knowledge sets 208 that correspond to Massachusetts learner's permits.

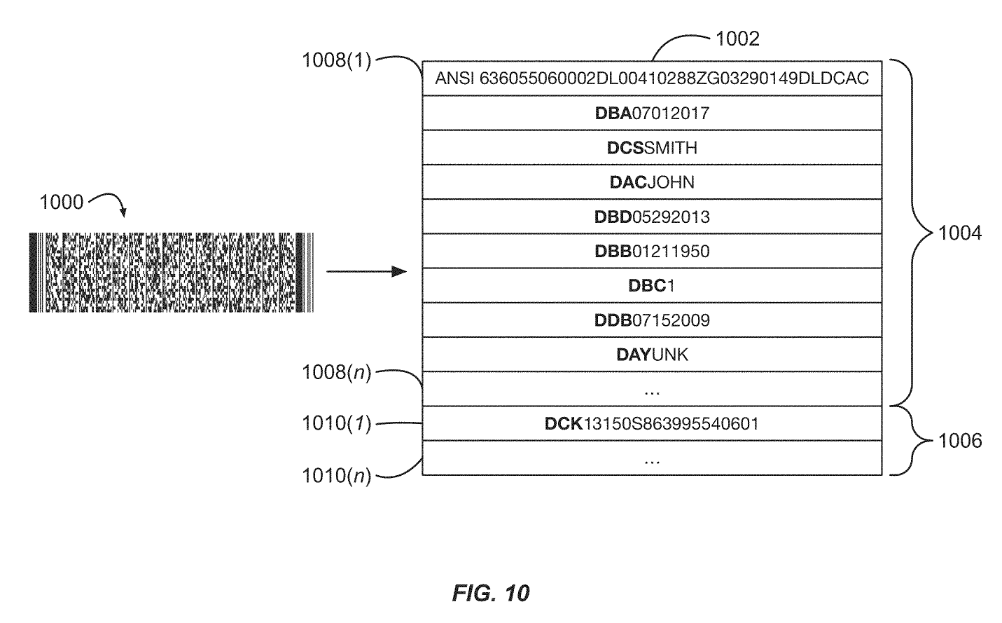

FIG. 10 illustrates an example PDF-417 barcode 1000 and the data 1002 extracted by the DCK engine. Also referring to FIG. 9, the barcode 1000 can be on a face of an unknown ID document, such as ID card 216. The client device 102 can capture an image of the barcode 1000 with the camera 214. The client device 102 can transmit the image to the authenticator server 201 via the network 104. The DCK engine 900 can extract the data 1002 from the image of the barcode 1000. According to the AAMVA specification, the data 1002 is organized in a predetermined manner. The data 1002 includes required data 1004 and optional data 1006. The required data 1004 includes a plurality of fields 1008(1)-1008(n) (collectively referred to as fields 1008). Each of the fields 1008 includes information about the ID document or holder of the ID document such as, but not limited to, family name, first name, middle name, card issue date, date of birth, expiration date, sex, height, and address. Each of the fields 1008 is identified by a heading. In some implementations, the heading is a three-digit or letter code. For example, according to the AAMVA specification, DCS is the heading for the last name field. Non-AAMVA specifications can also be used, such as mag-stripe formatted data that can be seen in Canada identification documents. Accordingly, the information following the heading DCS is the card holder's last name and should also correspond to the human readable information on the face of the ID document. The data in each of the fields can each have a predetermined structure, which can include an encoding that is unique to the field. The structure of the fields can also be used in determining the class, subclass, and authenticity of the ID document.

The data 1002 also includes optional data 1006 (also referred to as optional fields 1006). The optional data 1006 include fields 1010(1)-1010(n) (collectively referred to as fields 1010). As with the fields 1008, each of the fields 1010 are identified with a three-digit or letter heading. The data stored within the optional data 1006 is class (e.g., state) specific. In some implementations, the data stored within the optional data 1006 is undocumented and/or incidental. In some implementations, the optional fields 1006 can be referred to as undocumented fields or incidental fields. The undocumented data can be data that is not documented on a face of the ID document. For example, on a driver's license, the name of the person is documented on the face of the ID document. The undocumented data can be a control number, serial number, or hash of data on the face of the ID document. The undocumented data can also include data that is not publicized by the ID document's issuing authority, such as inventor control numbers. Within a class, the information stored within the optional data 1006 is consistent with other authentic members of the class. To be consistent between members of a class, the data stored within the optional data 1006 need not be identical, but can be generated with a consistent algorithm. For example, the information stored within one of the fields 1010 of the optional data 1006 can be a hash of information stored within one or more fields 1008 of the required data 1004. In this example, the field is not identical between members, but is consistent.

The number of fields 1010 and the information contained in each of the fields 1010 can vary between different classes. In some implementations, one example field 1010 found in the optional data 1006 of many classes is the inventory control field 1010(1). The inventory control field 1010(1) is identified by the three-digit code “DCK,” and may be referred to as a DCK field. As illustrated in FIG. 10, the inventory control field 1010(1) is identified by the code DCK followed by the information 131505863995540601.

Referring to FIG. 9 and also FIG. 10, the DCK engine 900 can execute one or more learning algorithms that can use machine learning to differentiate data retrieved from an ID document's barcode to classify the ID document into different classes and subclasses. In some implementations, due to the many classes and subclasses the information coding and sequence of coding within the optional data 1006 is not known. Because this information is not generally known, fraudulently manufactured ID documents that include a barcode often include incorrect data, incorrect data sequencing and design, incorrect formatting, missing data, and other various errors within the optional data 1006. The DCK engine 900 can identify these errors and then identify differences within the optional data 1006 between different classes and classify the ID document into different classes and subclasses without human intervention.

In some implementations, the DCK engine 900 is configured to normalize the priori knowledge stored in the database 206. In some implementations, without normalization, the DCK engine 900 can weight down document types that include a large number of documents in the training documents (e.g., the ID documents used to train the machine learning algorithm of the DCK engine 900). The DCK engine 900 can, without normalization, weight up documents types that did not include a large number of documents in the training documents. This can generate a bias towards documents with no major defining characteristics. The DCK engine 900 can include image processing normalization techniques to reduce this biases. For example, a weight normalization value can be generated based on the number of documents in each class. The weight normalization value can be multiplied against a classification score to provide a normalized value.

In some implementations, the DCK engine 900 can directly determine if an ID document is fraudulent based on the required data 1004 and/or optional data 1006 contained within a barcode without also analyzing the physical characteristics of the barcode (as described above in Section B). For example, the DCK engine 900 can detect matches to known forgeries or mismatches between the data retrieved from the barcode and the human readable portions of the ID document.

In some implementations, the DCK engine 900 can directly identify fraudulent ID documents based on the information contained within the data of the ID document's barcode. In some implementations, a fraudulent manufacture of ID documents can create ID documents with incorrectly generated barcodes. For example, the barcodes can include the wrong data, incorrect data design, incorrect formatting, missing data, extra data, or other various errors in the coding and sequencing of the barcode data. In some implementations, these errors are reproduced in each of the ID documents generated by the fraudulent manufacturer. Once identified, these errors can be stored in the database 206 as priori knowledge 208 and can be used as signatures to identify later ID documents manufactured by the fraudulent manufacture. For example, some data in the optional data 1006 portion of the barcode may not correspond to human readable portions of the ID document. For example, the inventory control number, as identified by the DCK heading, may not be printed on the face of the ID document. Because this information is difficult to reproduce and does not correspond to human readable information, the fraudulent manufacture may reuse the data in each its manufactured ID documents. After identifying one of the cards generated by the fraudulent manufacture (and the fraudulent manufacture's signature), the authenticator server can identify subsequent ID documents as fraudulent if they contain the same signature (e.g., an incorrect DCK field).

In some implementations, the DCK engine 900 can determine an ID document is fraudulent if there is a mismatch between the data contained within the barcode and the human readable data on the face of the ID document. For example, the required data 1004 of the barcode can include information such as the ID document owner's first and last name. In some implementations, the authenticator server can perform optical character recognition on the human readable portion of the ID document to extract the information printed on the face of the ID document such as, but not limited to the first name, last name, middle name, driving restrictions, date of birth, address, sex, eye color, height, and weight. The DCK engine 900 can compare this information to the data contained within the barcode. If there is a mismatch between the information on the face of the card and the data stored within the required or optional data fields of the barcode's data, then the ID document can be classified as fraudulent.

As described above, in some implementations, the DCK engine 900 classifies unknown ID documents to improve the accuracy of the authentication. In some implementations, the DCK engine 900 can classify unknown ID documents by state, document type, year, and authentication status. These classifications can become the root document classes. The DCK engine 900 can dynamically generate a list of paths for the ID document in each root class. The DCK engine 900 can also classify the ID document into subclasses within each of the root classes. The subclasses are also referred to as path classes. The DCK engine 900 can then loop through all ID documents per path class and generate a list of non-deltas, which can contain a score for how likely it is for the ID document to contain a specific feature. If the delta score is below a threshold score, the feature associate with the delta is discarded. This technique can enable the DCK engine's learning algorithms to ignore system output noise and to analyze characteristics of the ID document that are indicative of the ID document's authenticity. The DCK engine 900 can then compare the path class of the unknown ID document to the known path classes of previously analyzed ID documents to determine which path class the unknown path class most closely matches. The DCK engine 900 can then classify the unknown ID document into the class that the unknown path class most closely matches.

In some implementations, the DCK engine 900 plots the features of the ID document onto a feature-space. The previously authenticated ID documents can also be plotted onto the feature-space. The different classes and subclasses of previously authenticated ID documents can form clusters in the feature-space. The DCS engine 900 can determine the distance between the ID document being authenticated and one of the clusters. The score can be the distance between the ID document and one of the clusters. If the score is below a predetermined distance, the ID document can be authenticated.

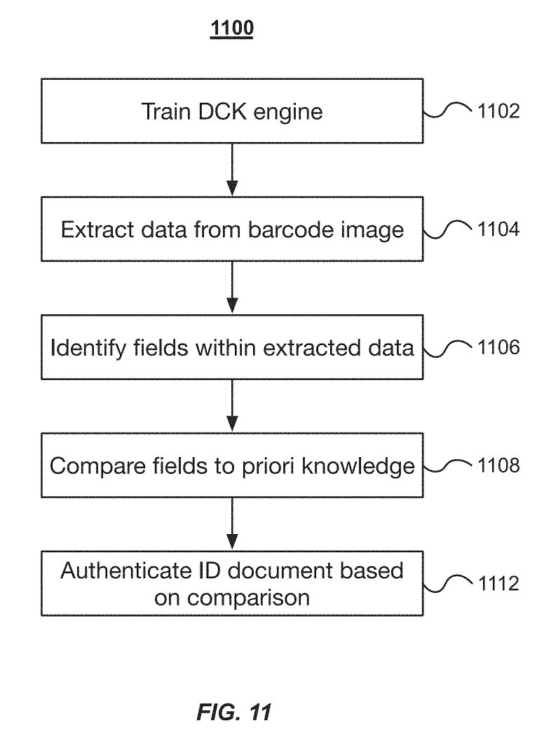

FIG. 11 illustrates a block diagram 1100 of a method for authenticating an ID document. The method includes training the DCK engine (BLOCK 1102). The method can include extracting data from a barcode image (BLOCK 1104). The method can include identifying fields within the extracted data (BLOCK 1106). The method can also include comparing the headings to known priori knowledge (BLOCK 1108). The method can include authenticating the ID document based on the comparison (BLOCK 1112).

As set forth above, the method can include training the DCK engine (BLOCK 1102). Training the DCK engine can include providing a plurality of ID documents in each of the document classes and subclasses to the DCK engine. For example, a plurality of driver's licenses from each state can be scanned and provided as input to the DCK engine. The DCK engine can scan the ID documents and extract the data from the barcode on the face of the ID documents. The DCK engine can then extract each of the fields and headings from the barcode data. Using a clustering algorithm, the extracted data can be clustered into different classes and then subclasses. In some implementations, the order of the fields 1008 can be used to determine the class and subclass of the ID document. The classes, subclasses, and extracted data can be saved into the authenticator server's database.

Once trained, the DCK engine can extract data from the barcode of an unknown ID document (BLOCK 1104). The DCK engine can receive the barcode as an image. The image can be received from a client device. In some implementations, the DCK engine is executed as a component of an authentication application executing on the client device. In other implementations, the DCK engine is executed as a component of an authentication manager executing on an authenticator server.

The method can also include identifying fields within the extracted data (BLOCK 1106). Also referring to FIG. 10, the DCK engine can process the image of the barcode and extract the data 1002 from the barcode image. The data 1002 can include required data fields 1004 and optional data fields 1006. Each of the fields can be identified by a heading. The DCK engine can parse the data 1002 to generate different data arrays that include the data from each of the fields.

The method can also include comparing the extracted fields to priori knowledge (BLOCK 1108). In some implementations, to classify the unknown ID document, the extracted data can first be compared against the priori knowledge (e.g., the classes and subclasses) generated during the training phase of the method (BLOCK 1102). The priori knowledge can be generated from previously authenticated ID documents. Once the DCK engine classifies the unknown ID document into a class (and possibly a subclass), the DCK engine can compare the extracted data to the training data associated with that class and subclass. The DCK engine can compare the optional fields, which can include data that is undocumented on the face of the card, that were extracted from the unknown ID document to the optional fields of the previously authenticated cards. Based on the comparison, the DCK engine can generate a score for the correlation between the training data and the data from the unknown ID document. The DCK engine can also compare the order and structure of fields to the order and structure of fields from authenticated ID documents. For example, and referring to FIG. 10, the fields 1008 for an authentic ID document should be in a predetermined order and structure. In a forged document, the order of the fields 1008 may be different order and structure. In one example, the forged ID document may include the field beginning with DCS in the second field rather than the third field.

The DCK engine can then authenticate the unknown ID document (BLOCK 1112). In some implementations, the score generated at BLOCK 1108 is a confidence percentage that is based on the difference between the training data and the data from the unknown ID document. The score can be generated using machine learning techniques such as neural networks and semantic networks. In some implementations, if the score is above a predetermined threshold the system authenticates the unknown ID document. If the score is below the predetermined threshold the system can indicate that the unknown ID document is fraudulent. In some implementations, the fields extracted from the barcode during the authentication of the unknown ID document are saved back to the authenticator server's database for use in authenticating subsequent unknown ID documents.

In some implementations, the score can also be based on a comparison of the data extracted from the barcode and data contained on the face of the ID document. For example, the DCK engine can determine required fields in the extracted data, such as the owner's name. The DCK engine can receive an image of the face of the ID documents and OCR the text on the face of the ID document. The DCK engine can compare the data extracted from the barcode to the OCRed text to determine if there is a mismatch between the data. If there is a mismatch, the system can determine the ID document is fraudulent. The system can increase the above-generated score if there is no mismatch between the data. For example, if the data extracted from the bar code includes “John Smith” in the name field, but “John Doe” is printed on the face of the ID document, the DCK system can detect the mismatch and indicate that the ID document is fraudulent.

### CONCLUSION

While the invention has been particularly shown and described with reference to specific embodiments, it should be understood by those skilled in the art that various changes in form and detail may be made therein without departing from the spirit and scope of the invention described in this disclosure.

While this specification contains many specific embodiment details, these should not be construed as limitations on the scope of any inventions or of what may be claimed, but rather as descriptions of features specific to particular embodiments of particular inventions. Certain features described in this specification in the context of separate embodiments can also be implemented in combination in a single embodiment. Conversely, various features described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

Having described certain embodiments of the methods and systems, it will now become apparent to one of skill in the art that other embodiments incorporating the concepts of the invention may be used. It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

What is claimed:

1. A system to determine a physical identification document is authentic using characteristics of the physical identification document, the system comprising:
an authentication manager executable on one or more processors configured to:
receive an image of a physical identification document, the image comprising a barcode of the physical identification document;
extract data from the barcode of the physical identification document;
determine a class of the physical identification document;
identify, based on the class of the physical identification document, an optional field in the data from the barcode, the optional field comprising data undocumented on a face of the physical identification document;
generate a score based on a comparison of the optional field in the data to an optional field of a previously authenticated physical identification document of the class; and
provide an indication that the physical identification document is authentic based on the score crossing a predetermined threshold.

2. The system of claim 1, comprising the authentication manager to receive the image of the physical identification document from a remote client device.

3. The system of claim 1, comprising the authentication manager to:
determine a subclass of the physical identification document; and
identify the optional field in the data based on the subclass of the physical identification document.

4. The system of claim 1, wherein the optional field comprises at least one of incidental data or an inventory control number.

5. The system of claim 1, wherein the optional field comprises a hash of at least one required field of the data.

6. The system of claim 1, comprising the authentication manager to:
identify, based on the class of the physical identification document, a required field in the data; and
generate the score based on the required field in the data.

7. The system of claim 6, comprising the authentication manager to compare data of the required field to a physical characteristic of the physical identification document.

8. The system of claim 7, wherein the physical characteristics is a human readable portion of the physical identification document.

9. The system of claim 1, comprising the authentication manager to determine a fraudulent manufacturer of the physical identification document based on the optional field in the data.

10. The system of claim 1, comprising the authentication manager to:
receive a second image of a second physical identification document, the second image comprising a second barcode of the second physical identification document;
identify a required field in the data of the second barcode;
compare data of the required field to a physical characteristic of the second physical identification document; and
provide an indication that the second physical identification document is fraudulent based on a mismatch between the data of the required field and the physical characteristic of the second physical identification document.

11. A method to determine a physical identification document is authentic using characteristics of the physical identification document, comprising:
receiving, by an authentication manager, an image of a physical identification document, the image comprising a barcode of the physical identification document;
extracting, by an element extraction engine executed by the authentication manager, data from the barcode of the physical identification document;
determining, by the authentication manager, a class of the physical identification document;
identifying, by the element extraction engine, based on the class of the physical identification document an optional field in the data, the optional field comprising data undocumented on a face of the physical identification document;
generating, by the authentication manager, a score based on a comparison of the optional field in the data to an optional field of a previously authenticated physical identification document of the class; and
providing, by the authentication manager, an indication that the physical identification document is authentic based on the score crossing a predetermined threshold.

12. The method of claim 11, further comprising receiving, over a network, the image of the physical identification document from a remote client device.

13. The method of claim 11, further comprising:
determining, by the authentication manager, a subclass of the physical identification document; and
identifying, by the authentication manager, the optional field in the data based on the subclass of the physical identification document.

14. The method of claim 11, wherein the optional field comprises at least one of incidental data or an inventory control number.

15. The method of claim 11, wherein the optional field comprises a hash of at least one required field of the data.

16. The method of claim 11, further comprising:
identifying, by the element extraction engine, based on the class of the physical identification document a required field in the data; and
generating, by the authentication manager, the score based on the required field in the data.

17. The method of claim 16, further comprising comparing, by the authentication manager, data of the required field to a physical characteristic of the physical identification document.

18. The method of claim 17, wherein the physical characteristics is a human readable portion of the physical identification document.

19. The method of claim 11, further comprising determining, by the authentication manager, a fraudulent manufacturer of the physical identification document based on the optional field in the data.

20. The method of claim 11, further comprising:
receiving, by the authentication manager, a second image of a second physical identification document, the second image comprising a second barcode of the second physical identification document;
identifying, by the element extraction engine, a required field in the data of the second barcode;
comparing, by the authentication engine, data of the required field to a physical characteristic of the second physical identification document; and
providing, by the authentication manager, an indication that the second physical identification document is fraudulent based on a mismatch between the data of the required field and the physical characteristic of the second physical identification.
